(19) United States
(12) Patent Application Publication
(10) Pub. No.: US 2012/0329020 A1
(43) Pub. Date: Dec. 27, 2012

(54) SYSTEMS AND METHODS FOR PRESONALIZED FATIGUE EDUCATION AND RISK MANAGEMENT

(75) Inventors: Daniel J. Mollicone, Philadelphia, PA (US); Christopher G. Mott, Seattle, WA (US)

(73) Assignee: Pulsar Informatics, Inc., Philadelphia, PA (US)

(21) Appl. No.: 13/406,109

(22) Filed: Feb. 27, 2012

Related U.S. Application Data
(60) Provisional application No. 61/446,570, filed on Feb. 25, 2011.

(51) Int. Cl. G09B 19/00

(52) U.S. Cl. 434/247

(57) ABSTRACT

A method is provided for ascertaining personalized education information related to one or more fatigue-related individual traits of a subject. The method involves: receiving first input data indicative of an expression of one or more fatigue-related individual traits of the subject; estimating trait values for the one or more fatigue-related individual traits, wherein estimating the trait values comprises: using the first input data and a fatigue model, which relates a fatigue level of the subject to a set of model parameters, to estimate values for the set of model parameters; and evaluating one or more trait-estimation functions using the estimated values for the set of model parameters; and determining personalized education information about the one or more fatigue-related individual traits of the subject based on the estimated trait values.

### RELATED APPLICATIONS

This application claims the benefit of the priority of U.S. application No. 61/446,570 filed 25 Feb. 2011 which is hereby incorporated herein by reference.

### TECHNICAL FIELD

The invention relates to personalized education information about fatigue-related individual traits. Particular embodiments provide systems and methods for providing such personalized education information and for providing suggestions for actions which mitigate risk associated with fatigue.

### BACKGROUND

Individuals can often determine when they are fatigued. However, fatigue levels and the impact of fatigue levels on other activities or the like can be influenced by fatigue-related individual traits which may be different among different individuals. For example, some individuals can function reasonably effectively on relatively little amounts of sleep or using short “cat naps”, whereas other individuals require significantly more sleep or significantly longer sustained periods of sleep to function with comparable effectiveness. Such differences may be related to inter-individual differences in fatigue-related traits.

An issue with traits is that they can be hard to measure. Furthermore, even if trait values for fatigue-related individual traits can be estimated, it can be difficult to interpret such trait value estimates into any type of information that is useful in the everyday life of an individual. For example, mere knowledge of trait value estimates for particular fatigue-related traits does not provide an individual with any recommendations about when they should work, when they should sleep or when they should take stimulants (e.g. caffeine) to function more effectively.

There is a general desire for providing personalized education information about fatigue-related traits for individuals.

### SUMMARY

One aspect of the invention provides a method for ascertaining personalized education information related to one or more fatigue-related individual traits of a subject. The method involves: receiving first input data indicative of an expression of one or more fatigue-related individual traits of the subject; estimating trait values for the one or more fatigue-related individual traits, wherein estimating the trait values comprises: using the first input data and a fatigue model, which relates a fatigue level of the subject to a set of model parameters, to estimate values for the set of model parameters; and evaluating one or more trait-estimation functions using the estimated values for the set of model parameters; and determining personalized education information about the one or more fatigue-related individual traits of the subject based on the estimated trait values.

Another aspect of the invention provides a method for ascertaining personalized education information related to one or more fatigue-related individual traits of a subject. The method involves providing a set of present model parameters for a present time, the set of present model parameters comprising a subset of model parameters based on one or more trait value estimates for one or more corresponding fatigue-related individual traits of the subject; providing a set of potential future activity data for the subject at one or more future evaluation times; providing a future-activity objective function which receives, as inputs, the present model parameters and the set of potential future activity data and which outputs a future cost value; performing a future-activity optimization process based on the future-activity objective function to obtain optimized future activity data at the one or more future evaluation times, wherein performing the future-activity optimization process comprises permitting the set of potential future activity data to vary until the future cost value output from the future-activity objective function is acceptably low; and determining personalized educational information based at least in part on the optimized future activity data.

Further details, features and aspect of particular embodiments are provided in the description below and in the drawings appended hereto.

### BRIEF DESCRIPTION OF DRAWINGS

Exemplary embodiments are illustrated in referenced figures of the drawings. It is intended that the embodiments and figures disclosed herein are to be considered illustrative rather than restrictive.

In drawings which illustrate non-limiting embodiments:

FIG. 1 is a schematic block diagram of a method for ascertaining personalized education information according to a particular embodiment;

FIG. 2A is a schematic block diagram of a method for using trait value estimates for fatigue-related individual traits of a subject to determine personalized education information according to a particular embodiment;

FIG. 2B is a schematic block diagram of a method for using trait value estimates for fatigue-related individual traits of a subject to determine personalized education information according to a particular embodiment;

FIG. 3 schematically depicts a display screen output showing a summary of personalized education information determined according to the method of FIG. 2A according to an example embodiment;

FIG. 4 is a schematic box diagram of a future-activity objective function suitable for use with the method of FIG. 2B according to a particular embodiment;

FIGS. 5A, 5B and 5C are schematic representations of example personalized education information that may be determined in accordance with a particular embodiment of the invention;

FIGS. 6A-6D show representative plots of future fatigue levels predicted by the fatigue-model of FIG. 4; and

FIG. 7 shows a schematic illustration of a system for providing personalized education information according to a particular, non-limiting, embodiment.

### DESCRIPTION

Before the embodiments of the invention are explained in detail, it is to be understood that the invention is not limited in its application to the details of construction and the arrangements of the operative components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including” and “comprising”, and variations thereof, is meant to encompass the items listed thereafter and equivalents thereof. Unless otherwise specifically stated, it is to be understood that steps in the methods described herein can be performed in varying sequences.

As will be described in more detail below, aspects of the invention provide systems and methods for ascertaining personalized education information about a fatigue-related individual trait of a subject. Systems and methods comprise: receiving first input data indicative of an expression of a fatigue-related individual trait of the subject; estimating a trait value for the fatigue-related individual trait using the first input data and a fatigue model which relates the first input data to one or more model parameters and wherein the estimated trait value comprises a function of the one or more model parameters; and determining personalized education information about the fatigue-related individual trait of the subject based on the estimated trait value.

Aspects of the invention also provide systems and methods for ascertaining personalized education information about one or more fatigue-related individual traits of a subject. The systems and methods comprise: providing a set of present model parameters for a present time, the set of present model parameters comprising a subset of model parameters based on one or more trait value estimates for one or more corresponding fatigue-related individual traits of the subject; providing a set of potential future activity data for the subject at one or more future evaluation times; providing a future-activity objective function which receives, as inputs, the present model parameters and the set of potential future activity data and which outputs a future cost value; performing a future-activity optimization process based on the future-activity objective function to obtain optimized future activity data at the one or more future evaluation times, wherein performing the future-activity optimization process comprises permitting the set of potential future activity data to vary until the future cost value output from the future-activity objective function is acceptably low; and determining personalized educational information based at least in part on the optimized future activity data.

Embodiments of the invention make use of fatigue models and objective functions derived from such fatigue models. Fatigue models may output a fatigue value or metric for a subject at a particular time t based on some function ƒ(X,t) where X is a vector X=[x₁, x₂, . . . xₙ]^{T} representing one or more model parameters xᵢ. One or more model parameters X may be functions of time up to and including the time t. One or more of model parameters X may comprise statistical parameters represented by probability distributions, probability distribution functions and/or parameters representative of such probability distributions or probability distribution functions. Fatigue models are often used interchangeably with alertness models, it being appreciated that alertness is inversely correlated with fatigue. In such circumstances, an explicit relationship (e.g. a mapping, transformation and/or the like) may be defined between alertness level and fatigue.

While it is explicitly recognized that the systems and methods of the invention may make use of a variety of suitable fatigue models, in one particular embodiment, embodiments of the invention make use of the so called “two-process model” of sleep regulation developed by Borbély et al. 1999. This model posits the existence of two primary regulatory mechanisms: (i) a sleep/wake-related mechanism that builds up exponentially during the time that a subject is awake and declines exponentially during the time that the subject is asleep, called the “homeostatic process” or “process S”; and (ii) an oscillatory mechanism with a period of (nearly) 24 hours, called the “circadian process” or “process C”. Without wishing to be bound by theory, the circadian process has been demonstrated to be orchestrated by the suprachiasmatic nuclei of the hypothalamus. The neurobiology of the homeostatic process is only partially known and may involve multiple neuroanatomical structures.

In accordance with the two-process model, the circadian process C may be represented by:

$$C ( t ) = γ {\sum }_{l = 1}^{5} {a}_{l} sin ( 2 l π ( t - φ ) / τ ) \qquad ( 1 )$$

where t denotes clock time (in hours, e.g. relative to midnight), [symbol] represents the circadian phase offset (i.e. the timing of the circadian process C relative to clock time), [symbol] represents the circadian amplitude, and represents the circadian period which may be fixed at a value of approximately or exactly 24 hours. The summation over the index l serves to allow for harmonics in the sinusoidal shape of the circadian process. For one particular embodiments of the two-process model for alertness prediction, l has been taken to vary from 1 to 5, with the constants aₗ being fixed as a₁=0.97, a₂=0.22, a₃=0.07, a₄=0.03, and a₅=0.001. It will be appreciated that [symbol] , [symbol] and represent model parameters.

The homeostatic process S may be represented by:

$$S ( t ) = \{ \begin{matrix}{e}^{- {ρ}_{w} Δ t} {S}_{t - Δ t} + ( 1 - {e}^{- {ρ}_{w} Δ t} ) & if during wakefuleness & ( 2 a ) \\ {e}^{- {ρ}_{s} Δ t} {S}_{t - Δ t} & if during sleep & ( 2 b )\end{matrix} \qquad$$

(S>0), where t denotes (cumulative) clock time, [symbol] t represents the duration of time step from a previously calculated value of S, [symbol] _{w} represents a rate of increase of fatigue of the homeostatic process for an individual during wakefulness ( [symbol] _{w} may be referred to as the rate of homeostatic buildup) and [symbol] ₛ represents a rate of decrease of the homeostatic process for an individual during sleep ( [symbol] ₛ may be referred to as the rate of homeostatic recovery). It will be appreciated that [symbol] _{w} and [symbol] ₛ represent model parameters.

Given equations (1), (2a) and (2b), the total fatigue according to the two-process model may be expressed as a sum of: the circadian process C, the homeostatic process S multiplied by a scaling factor [symbol] and an added noise component (t):

ƒ(X,t)= [symbol] S(X,t)+C(X,t)+(t) (3)

Further details of this particular fatigue model are provided in PCT patent publication No. WO2009/052633 which is hereby incorporated herein by reference.

Embodiments of the invention use fatigue models and/or their model parameters to estimate trait values for fatigue related individual traits which may not be directly measurable or observable. As used in this description and the accompanying claims, the word “trait” is used to refer to a characteristic of a particular individual subject that have enduring (i.e. relatively non-time-varying) values for the individual subject. Traits differ as between individual subjects. Non-limiting examples of fatigue-related individual traits for a subject include: whether the subject is alert on a minimum amount of sleep; whether the subject is a “night owl” (i.e. relatively more alert late at night) or a “morning person” (i.e. relatively more alert in the early morning); the rate of fatigue level increase for the subject during wakefulness (e.g. the rate of homeostatic buildup ( [symbol] _{w})); the rate of fatigue level reduction for the subject during sleep (e.g. the rate of homeostatic recovery ( [symbol] ₛ)); the extent to which time of day (circadian rhythm) influences alertness for the subject (e.g. circadian amplitude (γ)); aptitude for specific performance tasks for the subject; other traits for the subject described in Van Dongen et al., 2005 (Van Dongen et al., “Individual difference in adult human sleep and wakefullness: Leitmotif for a research agenda.” Sleep 28 (4): 479-496. 2005), which is hereby incorporated herein by reference.

An individual's traits may be contrasted with the individual's “states”. As used in this description and the accompanying claims, the word “state” is used to describe characteristics of a particular individual which vary with time and which may one or more circumstances or external conditions (e.g. sleep history, light exposure, etc.). Non-limiting examples of individual states of a subject include: the amount of sleep that the subject had in the immediately preceding day(s); the level of homeostatic process of the subject at the present time; the circadian phase of the subject (Czeisler, C., Dijk, D, Duffy, J., “Entrained phase of the circadian pacemaker serves to stabilize alertness and performance throughout the habitual waking day,” Sleep Onset: Normal and Abnormal Processes, pp 89_{—}110, 1994 (“Czeisler, C. et al.”)); the current value of light response sensitivity in the circadian process (Czeisler, C., Dijk, D, Duffy, J., “Entrained phase of the circadian pacemaker serves to stabilize alertness and performance throughout the habitual waking day,” pp 89_{—}110, 1994); the levels of hormones for the subject such as cortisol, or melatonin, etc (Vgontzas, A. N., Zoumakis, E., et al., “Adverse effects of modest sleep restriction on sleepiness, performance, and inflammatory cytokines” Journal of Clinical Endocrinology and Metabolism 89(5): 2119_{—}2126, 2004); the levels of pharmological agent(s) for the subject known to affect alertness such as caffeine, or modifinal (Kamimori, G. H., Johnson, D., et al., “Multiple caffeine doses maintain vigilance during early morning operations.” Aviation Space and Environmental Medicine 76(11): 1046_{—}1030, 2005). The references referred to in this paragraph are hereby incorporated herein by reference.

Fatigue models ƒ(X,t) may generate fatigue predictions for a subject based on such external conditions. Such external conditions, which may be time varying, may be reflected in, or otherwise incorporate into, one or more of the model parameters X. Non-limiting examples of external conditions which may be incorporated into the model parameters X of a fatigue model ƒ(X,t) include: the activity history (e.g. sleep history and/or wakeful activity history) of the subject; light exposure; quantity and timing of caffeine intake; and/or the like. As one particular example, a model variable xᵢ in the set of model parameters X may be reflective of the caffeine level (e.g. in mg or some other suitable unit) present in the subject. The model variable xᵢ may be a function of historical time up to and including the present time t.

Embodiments of the invention use fatigue models and/or their model parameters to estimate trait values for fatigue related individual traits. If a fatigue model for an individual is given by ƒ(X,t) where X is a set of model parameters as described above, then embodiments of the invention may use one or more trait-estimation functions gᵢ(X) of the model parameters X to estimate values for one or more corresponding fatigue-related individual traits. It will be appreciated that there may be a unique trait-estimation function gᵢ(X) for each fatigue-related individual trait. For some particular models, one or more model parameters x₁, x₂, . . . xₙ that make up the model parameter vector X=[x₁, x₂, . . . xₙ]^{T} may directly provide an estimate of an individual trait. This is the case, for example, with the above-discussed two-process model, where: the model parameter [symbol] _{w} provides a direct estimate of the fatigue-related individual trait of the rate of homeostatic buildup; the model parameter [symbol] ₛ provides a directed estimate of the fatigue-related individual trait of the rate homeostatic recovery; and the model parameter γ provides a direct estimate of the fatigue-related individual trait of circadian amplitude.

Embodiments of the invention use estimated trait values for fatigue related individual traits to determine personalized education information relating to an individual subject.

In this description and the accompanying claims, the term “subject” is used to refer to an individual (typically, although not exclusively, a human being) from whom data is collected and about whom the outputted personalized education information is tailored to. In contrast, a “user” is used to refer to a person or organization that may be supervising the operation of the methods and systems described herein and that may make use of the personalized education information about the subject. In some embodiments, the subject and the user may be the same individual. In other embodiments, users and subjects may be different individuals and may have a variety of different relationships. By way of non-limiting example: users may comprise corporate or individual employers who may have an interest in monitoring, educating or improving the performance of subjects who may be employees; users may comprise military officers or commanders who may have an interest in overseeing military units which may include groups of subjects; users may include one or more researchers who may want to collect research data to test populations of users; and/or the like.

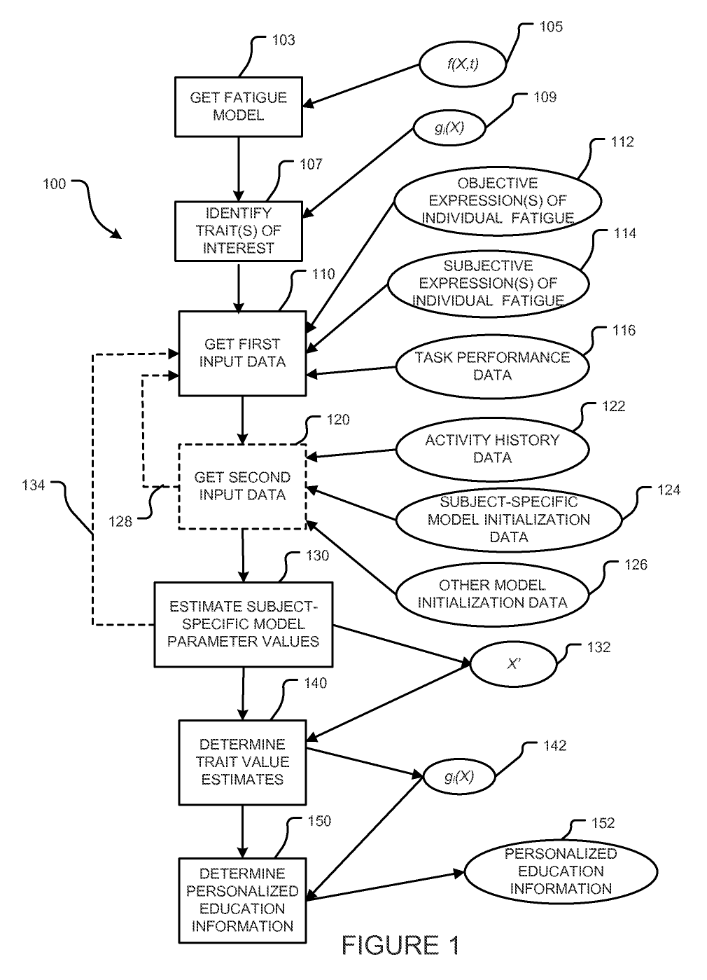

FIG. 1 is a block diagram depiction of a method 100 for ascertaining personalized education information according to a particular embodiment. Method 100 starts in block 103 which involves procuring a fatigue model 105. As discussed above, fatigue model 105 may comprise a model which outputs a fatigue value or metric for a subject at a particular time t based on some function ƒ(X,t) where X is a vector X=[x₁, x₂, . . . xₙ]^{T} representing one or more model parameters. Model parameters X may themselves comprise functions of times up to and including the time t. In some embodiments, the particular fatigue model 105 procured in block 103 may be a user-configurable parameter. In other embodiments, the fatigue model 105 procured in block 103 may be a pre-configured characteristic of method 100.

Block 107 involves the identification of one or more individual traits 109 of interest. The block 107 individual traits 109 may comprise fatigue-related individual traits 109. Non-limiting examples of fatigue-related individual traits 109 which may be identified as fatigue-related individual traits 109 of interest in block 107 are discussed above. In the particular case where the block 103 fatigue model 105 is represented by the function ƒ(X,t), the block 107 fatigue-related individual traits 109 of interest may be represented by one or more trait-estimation functions gᵢ(X) of the model parameters X. In some embodiments, fatigue-related traits 109 of interest may be user-specified in block 107. In other embodiments, fatigue-related traits 109 of interest may be pre-configured characteristic(s) of method 100.

Method 100 then proceeds to block 110 which involves procuring first input data. The block 110 first input data is indicative of one or more measurable or observable expressions of one or more fatigue-related traits of an individual subject at one or more corresponding times. The expressions of fatigue-related individual traits for which first input data is obtained in block 110 differ from the individual traits themselves in that the expressions of these individual traits may be measured or observed. In some embodiments, the measurable or observable expressions of fatigue-related individual traits may be compared to one another. The block 110 first input data may comprise quantification data (e.g. a metric) or qualitative data (e.g. a category) indicative of the measured or observed expression of fatigue-related individual traits. For brevity, the block 110 first input data may be referred to herein as being measured and it will be understood that measurement may include other forms of observation that may not be strictly measured per se. In particular embodiments, the block 110 first input data comprises a plurality of data indicative of expressions of one or more fatigue-related traits measured at a corresponding plurality of times.

In particular embodiments, block 110 involves obtaining one or more measurements of an individual subject's fatigue level at one or more corresponding times and the block 110 first input data represents fatigue level data output from such measurements. Measurement of fatigue may either come from one or more objective (quantitatively measured) sources 112 and/or one or more subjective (judgement-based) sources 114. An example of a subjective source 114 of block 110 fatigue level data comprises a subject-reported sleepiness survey. Non-limiting examples of such surveys include: the Karolinska sleepiness scale, the Stanford sleepiness scale, the Epworth sleepiness scale, the Pittsburgh sleep quality index and/or the like. An example of an objective source 112 of block 110 fatigue level data comprises the output from a test that measures the subject's neurobehavioral performance. Non-limiting examples of such neurobehavioral performance tests include: the psychomotor vigilance test (“PVT”), the digital symbol substitution test (“DSST”) and/or the like.

Additionally or alternatively, block 110 involves obtaining one or more measurements of an individual subject's performance when performing a specific task at one or more corresponding times and the block 110 first input data represents task performance data 116 output from such performance measurements. Non-limiting examples of task performance measurements capable of generating task performance data 116 comprise: a real or simulated vehicular lane tracking system which measures the performance of a subject to drive a vehicle while staying in a lane; a real or simulated target practice system which measure the performance of a subject to fire a weapon at a target; a real or simulated job performance system which measures the performance of a subject to do a particular job and/or the like. Such block 110 task performance data 116 may help method 100 to provide relatively more accurate personalized education information relating to the subject and the specific task in question.

In some embodiments, the block 110 procurement of first input data may optionally involve subjecting the subject to one or more stressors (not shown), which stressors may be designed to expose or otherwise enhance inter-individual differences in the expression of particular fatigue-related trait(s). For example, if a particular fatigue-related trait of interest is susceptibility to fatigue generally, then suitable stressors may include, without limitation: restricting the subject's sleep schedule (e.g. sleep amount, available sleep times and/or the like); requiring the subject to perform tasks (instead of sleeping) at particular times; and/or the like. Subjecting the subject to such stressors may help to expose the subject's expression of their susceptibility to fatigue to a suitable measurement technique used to procure the block 110 first input data. For example, if the block 110 first input data is procured via a specific task performance measurement and two subjects (one with a relatively high susceptibility to fatigue and one with a relatively low susceptibility to fatigue) are subjected to the same restricted-sleep stressors, then it would be expected that the subject with relatively high susceptibility to fatigue will perform relatively more poorly on the specific task performance measurement test than the subject with relatively low susceptibility to fatigue.

It will be appreciated by those skilled in the art that suitable stressors could be designed and administered to subjects to expose inter-individual differences between subjects in the expression of particular fatigue-related traits of interest. While the application of stressors in block 110 is optional, without the application of stressors, the differences in the block 110 first input data as between individual subjects may be relatively more subtle.

After obtaining the block 110 first input data, method 100 may proceed to optional block 120 which involves procuring second input data. In general, the block 120 second input data may comprise any data which may have an influence on the block 103 fatigue model 105. In particular embodiments, the block 120 second input data may be used to ascertain initial values for one or more model parameters in the set X of model parameters corresponding to fatigue model ƒ(X,t) 105. In particular embodiments, the block 120 second input data may be used to ascertain values at the evaluation time t for one or more model parameters in the set X of model parameters corresponding to fatigue model ƒ(X,t) 105, where such values of the model parameters at the evaluation time t may depend on historic time up to and including the evaluation time t and/or external conditions at historic times up to and including the evaluation time t. As discussed above, one or more of model parameters X may comprise statistical parameters represented by probability distributions, probability distribution functions and/or parameters representative of such probability distributions or probability distribution functions. Accordingly, the block 120 second input data may also comprise probability distributions, probability distribution functions and/or parameters representative of such probability distributions or probability distribution functions.

In particular embodiments, the block 120 second input data comprises activity history data 122. Activity history data 122 may be subject-specific—i.e. activity history data 122 may be related to the particular individual that is the subject of method 100. Activity history data 122 may comprise data related to activities up to and including the time of evaluation t of the block 103 fatigue model 105. Activity history data 122 may comprise sleep history data (e.g. a historic sleep/wake schedule and/or the like) and/or wakeful activity history data (e.g. a historic schedule of work, history of stimulant (e.g. caffeine) intake and/or other wakeful activities). Activity history data 122 may come from objective sources and/or from subjective sources. For example, sleep history data may be objectively ascertained from an actigraphy sensor or the like and/or subjectively ascertained from a subject-reported sleep log or diary. Subjective activity history data 122 may include qualitative data. For example, subjective sleep history data may include an indicator of sleep quality and/or the like. Wakeful activity history may be subject-reported. Wakeful activity history data may additionally or alternatively come from suitable scheduling data (e.g. an employer's scheduling system and/or the like).

Block 120 may involve processing activity history data 122 to incorporate activity history data 122 into the block 103 fatigue model 105 or otherwise incorporating activity history data 122 into the block 103 fatigue model 105. In particular embodiments, block 120 may involve incorporating activity history data 122 into the block 103 fatigue model 105 in the form of one or more model parameters xᵢ within the set X of the model parameters of the fatigue model ƒ(X,t). Such model parameters may depend on historic time up to and including the evaluation time t and/or external conditions at historic times up to and including the evaluation time t. As will be understood by those skilled in the art and familiar with fatigue models, the specific manner in which activity history data 122 is incorporated into model parameters X depends on the characteristics of the particular fatigue model ƒ(X,t) and the specific characteristics of activity history data 122.

In particular embodiments, the block 120 second input data comprises subject-specific model initialization data 124. Subject-specific model initialization data 124 may comprise a profile (e.g. a database record) corresponding to the individual who is the subject of method 100. In some cases, the individual who is the subject of method 100 may have been a subject for a previous iteration of method 100 and/or related testing and a subject profile may be available to method 100 (e.g. stored in accessible memory and/or the like). Such a subject profile may comprise, by way of non-limiting example: personal identification data (e.g. name, employee number and/or the like), demographic data (e.g. age, sex, ethnicity, occupation and/or the like) and/or other metadata corresponding to the subject; previously estimated trait values for fatigue-related individual traits of the subject; model parameters previously used for the subject; activity history data corresponding to the subject; other data that has been collected or generated in previous iterations of method 100 and/or related testing; and/or the like.

It is not necessary that subject-specific model initialization data 124 be provided in the form of a subject-specific profile. In some embodiments, subject-specific model initialization data 124 may be provided using other techniques. In some embodiments, the subject (or a user) may be asked to provide subject-specific model initialization data 124 through a suitable interrogation process. By way of non-limiting example, the subject (or a user) may be interrogated to provide: personal identification data (e.g. name, employee number and/or the like), demographic data (e.g. age, sex, ethnicity, occupation and/or the like) and/or other metadata corresponding to the subject; particular initial values for one or more of the model parameters X; and/or the like. In some embodiments, data obtained through such interrogation may be used to create a portion of a subject-specific profile for a subsequent iteration of method 100.

Block 120 may involve processing subject-specific model initialization data 124 to incorporate subject-specific model initialization data 124 into the block 103 model 105 or otherwise incorporating subject-specific model initialization data 124 into the block 103 fatigue model 105. In particular embodiments, block 120 may involve incorporating subject-specific model initialization data 124 into the block 103 fatigue model 105 in the form of one or more model parameters xᵢ within the set X of the model parameters of the fatigue model ƒ(X,t). Such model parameters may depend on historic time up to and including the evaluation time t and/or external conditions at historic times up to and including the evaluation time t. As will be understood by those skilled in the art and familiar with fatigue models, the specific manner in which subject-specific model initialization data 124 is incorporated into model parameters X depends on the characteristics of the particular fatigue model ƒ(X,t) and the nature of subject-specific model initialization data 124.

In particular embodiments, the block 120 second input data comprises other model initialization data 126. Other model initialization data 126 may generally comprise any other information required to parameterize or otherwise make use of fatigue model 105. Other model initialization data 126 may comprise initial and/or enduring values for one or more of the model parameters X. In particular embodiments, other model initialization data 126 may comprise data based on a population average. In some cases, the population average may comprise a general population, a subset of the general population based on similarities in personal and/or demographic data of the population subset and the subject of method 100, a subset of the population based on some other characteristic shared by the population subset and the subject of method 100 (e.g. the population subset and the subject have the same vocation and/or the like), and/or the like.

Block 120 may involve processing other model initialization data 126 to incorporate other model initialization data 126 into the block 103 model 105 or otherwise incorporating other model initialization data 126 into the block 103 fatigue model 105. In particular embodiments, block 120 may involve incorporating other model initialization data 126 into the block 103 fatigue model 105 in the form of one or more model parameters xᵢ within the set X of the model parameters of the fatigue model ƒ(X,t). As will be understood by those skilled in the art and familiar with fatigue models, the specific manner in which other model initialization data 126 is incorporated into model parameters X depends on the characteristics of the particular fatigue model ƒ(X,t) and the nature of other model initialization data 126.

In some circumstances, it can be desirable to repeat the procedures of blocks 110 and 120 for a plurality of times t=T₁, T₂, . . . Tₖ which may be referred to as evaluation times. By way of non-limiting example, such repetition can be desirable in circumstances where the block 110 first input data is available for a plurality of evaluation times t=T₁, T₂, . . . Tₖ. It will be appreciated that the fatigue model used in the block 130 optimization (discussed further below) may vary for each such evaluation time t=T₁, T₂, . . . Tₖ. For example, it will be appreciated that where the fatigue model is ƒ(X,t), then the fatigue model ƒ(X,t) is an express function of the evaluation time t. Furthermore, one or more of the model parameters xᵢ in the set X of model parameters may also depend on historic time up to and including the evaluation time t and/or external conditions at historic times up to and including the evaluation time t. Examples of model parameters which vary based on the evaluation time t include those model parameters based on activity history data 122, since only activity history data up to and including the current evaluation time t is taken into the fatigue model during block 120. Repetition of blocks 110 and 120 for each evaluation time t=T₁, T₂, . . . Tₖ can yield a set of different fatigue models (one for each evaluation time t=T₁, T₂, . . . Tₖ) which may be used in the block 130 optimization. This repetition of blocks 110 and 120, which may be implemented by a FOR . . . NEXT loop, for example, is schematically depicted in FIG. 1 by dashed line 128.

At the conclusion of the last iteration of block 120, method 100 proceeds to block 130 which involves using the block 103 fatigue model 105 (as parameterized by any block 120 second input data) together with the block 110 first input data to estimate subject-specific model parameter values 132. In embodiments where fatigue model 105 is represented by the function ƒ(X,t), subject-specific model parameter values 132 estimated in block 130 may comprise values for a subset X′ of the model parameters X. As discussed above, in some embodiments, one or more of model parameters X may comprise statistical parameters represented by probability distributions, probability distribution functions and/or parameters representative of such probability distributions or probability distribution functions. Accordingly, subject-specific model parameter values 132 estimated in block 130 may actually comprise expected values for probability distributions and/or probability distribution functions and/or other parameters representative of such probability distributions or probability distribution functions corresponding to the subset X′ of the model parameters X. Non-limiting examples of statistical parameters of probability distributions or probability distribution functions that may be estimated in block 130 and which may form part of the subject-specific model parameter values 132 include standard deviation, variance and/or some other statistical confidence metric corresponding to the subset X′ of the model parameters X. For brevity, subject-specific model parameter values 132 may be referred to herein as “estimates” or “values” or the like without loss of generality that such “estimates” or “values” or the like may actually include expected values and/or other statistical parameters of probability distributions and/or probability distribution functions.

In particular embodiments, block 130 may involve performing an optimization (e.g. curve-fitting) operation which allows a subset X′ of the model parameters X to vary so that the fatigue model predicts (or fits) the block 110 first input data to an acceptably accurate level. The block 130 optimization may be performed over a set of evaluation times t=T₁, T₂, . . . Tₖ. In general, the block 130 optimization operation may comprise any suitable optimization technique. Non-limiting examples of suitable optimization techniques include: least squares fitting, Newton's method, the simplex method, quasi-Newton methods, simulated annealing, genetic search algorithms and/or the like. The block 130 optimization process may involve minimizing an objective (cost) function which is representative of a difference metric between the block 110 first input data and a set of one or more fatigue levels predicted by fatigue model 103 at a set of one or more corresponding evaluation times t=T₁, T₂, . . . Tₖ. It will be appreciated that the block 130 optimization need not reach a global objective function minimum. In some embodiments, it is sufficient that the fatigue model approximates (or fits) the block 110 first input data to an acceptably accurate level (e.g. the objective function of the block 130 optimization be reduced to some acceptably low level). The output of the block 130 optimization procedure is a set of subject-specific model parameter values 132 which, when used in the fatigue model, cause the fatigue model to best approximate first input data 110. Where the fatigue model is of the form ƒ(X,t), the subject-specific model parameter values 132 generated in the block 130 optimization may comprise a subset X′ of the model parameters X.

While not expressly shown in FIG. 1, method 100 may involve ascertaining some calibration information relating to the block 130 optimization process. For example, such calibration information may include the particulars of the subset X′ of model parameters X which are permitted to vary during the optimization. Such a subset X′ of model parameters X may comprise model parameters that are related to the block 107 fatigue-related individual traits of interest 109 (e.g. a subset X′ of the model parameters X which will permit the calculation of the functions gᵢ(X)). Calibration information may also specify that a different subset X″ of the set X of model parameters should remain constant during the block 130 optimization for any particular evaluation time t=T₁, T₂, . . . Tₖ. For example, the subset X″ of model parameters X that is constant during the block 130 optimization for any particular evaluation time t=T₁, T₂, . . . Tₖ may include those model parameters derived from activity history data 122. As another example, such calibration information may also include one or more constraints on the block 130 optimization. Such constraints may include, for example, minimum and/or maximum constraints to which the subset X′ of the model parameters X that are permitted to vary during the optimization. As another example, such calibration information may include suitable optimization termination conditions—i.e. conditions for determining when the fatigue model predicts (or fits) the block 110 first input data to an acceptably accurate level.

In particular embodiments, block 130 may involve using a statistical modeling techniques, such as Bayesian forecasting by way of non-limiting example, to determine a statistically optimum set of model parameters 132 which cause the fatigue model to best approximate the block 110 first input data. Such Bayesian forecasting techniques are described, for example, in PCT patent publication No. WO2009/052633.

When using a statistical method, such as Bayesian forecasting for example, to determine the set of subject-specific model parameter values 132, it may be beneficial to iterate through the forecasting method as more block 110 first input data becomes available. For example, in circumstances where the block 110 first input data is available at a plurality of evaluation times t=T₁, T₂, . . . Tₖ, it may be desirable to iterate through the forecasting method at each evaluation time t=T₁, T₂, . . . Tₖ. Usually, when more statistical modeling iterations occur, the resultant estimates of the subject-specific model parameter values 132 will be relatively more accurate. To take advantage of this characteristic of statistical modeling, in some embodiments, method 100 may comprise an iteration loop 134 which executes once for each evaluation time t=T₁, T₂, . . . Tₖ. In each loop, the block 110 first input data and any available updates to second input data (e.g. new activity history data) are procured for the current evaluation time t. The block 130 Bayesian forecasting procedure may then be performed iteratively for each evaluation time t=T₁, T₂, . . . Tₖ, so as to iteratively update the set of subject-specific model parameter values 132.

In some embodiments, the block 110 first input data and the output of the fatigue model may be provided in different output spaces, in different units and/or the like. In such cases, block 130 may involve the application of a transformation to the output of the fatigue model, to the block 110 first input data or both to facilitate direct comparison of the output of the fatigue model to the block 110 first input data. For example, the block 110 first input data may be transformed to the “fatigue space” output from fatigue model 105, so that that output from fatigue model 105 can be directly compared to the block 110 first input data during the block 130 optimization.

Ultimately, block 130 concludes with estimates for a set of subject-specific model parameter values 132 which may comprise values for a subset X′ of the model parameters X. As discussed above, such subject-specific model parameter values 132 may actually comprise expected values for probability distributions and/or probability distribution functions and/or other statistical parameters (e.g. variance, standard deviation and/or other confidence indicators) representative of such probability distributions or probability distribution functions corresponding to the subset X′ of the model parameters X. Such a subset X′ may comprise a subset X′ of model parameters X that are related to the block 107 fatigue-related individual traits of interest 109 (e.g. a subset X′ of the model parameters X which will permit the calculation of the functions gᵢ(X)).

Method 100 then proceeds to block 140 which involves using the block 130 subject-specific model parameter value estimates 132 to determine trait value estimates 142 for the block 107 fatigue-related individual traits of interest 109. More particularly, for each of the block 107 fatigue-related individual traits of interest 109, method 100 may involve calculating (or otherwise determining) a trait value estimate 142 using the corresponding function gᵢ(X) evaluated using the block 130 subject-specific model parameter value estimates 132. Where subject-specific model parameter values 132 estimated in block 130 comprise statistical values of the type discussed above, the corresponding block 140 trait value estimates 142 may similarly comprise expected values for probability distributions and/or probability distribution functions and/or other parameters representative of such probability distributions or probability distribution functions. Non-limiting examples of statistical parameters of probability distributions or probability distribution functions that may be determined in block 140 and which may form part of the trait value estimates 142 include standard deviation, variance and/or some other statistical confidence metric. For brevity, trait value estimates 142 may be referred to herein as “estimates” or “values” without loss of generality that such “estimates” or “values” may actually include expected values and/or other statistical parameters of probability distributions and/or probability distribution functions.

Method 100 then proceed to block 150 which involves using the block 140 trait value estimates 142 as a basis for determining personalized education information 152. Personalized education information 152 may comprise information about the block 140 trait value estimates 142 and/or may otherwise be based on the block 140 trait value estimates 142. The block 150 personalized education information 152 may be output to a user in the form of report which may be printed and/or displayed on a computer screen, for example.

In particular embodiments, personalized education information 152 may comprise trait value estimates 142, which may be expressed in their native scale, on a desired scale (e.g. a value between 0-100), as a percentile or other suitable ranking within a particular population and/or the like. When expressed as a percentile or some other suitable ranking within a population, such a population may include the general population or any suitable sub-population (e.g. a workforce, a group of athletes, a group of soldiers and/or the like). Personalizes education information 152 may additionally or alternatively comprise statistical information related to trait value estimates 142. For example, personalized education information may include the variance, standard deviation or some other level of confidence in the trait value estimates 142.

In particular embodiments, personalized educational information 152 may comprise subject-specific educational content including information about the subject of method 100 which is based on the particular values of the trait value estimates 142 for that subject. Non-limiting examples of such information may include: information describing how susceptible the subject will be to cyclical (circadian) fatigue effects based on a trait 142 value estimate corresponding to the subject's circadian amplitude trait (γ); information describing how the subject may or may not be able to take advantage of short “cat naps” to avoid fatigue based on a trait value estimate 142 corresponding to the subject's homeostatic decay rate ( [symbol] ₛ); information about exposed vulnerabilities relating to trait value estimates 142 that have values that are statistically different from normal; and/or the like.

In particular embodiments, personalized education information 152 comprises specific recommendations of future activities (or changes to future activities) which may reduce future fatigue risk. In particular embodiments, personalized education information 152 comprises specific recommendations for the use of countermeasures which may reduce future fatigue risk. Such countermeasures may include introducing new sleep periods, modifying the timing or duration of planned sleep periods, introducing caffeine intake or other such stimulants, modifying the timing and quantity of caffeine intake or other such stimulants, modifying periods of critical work activities to coincide with times in which fatigue levels are lower, modifying work activity to include additional error preventative actions, and the like.

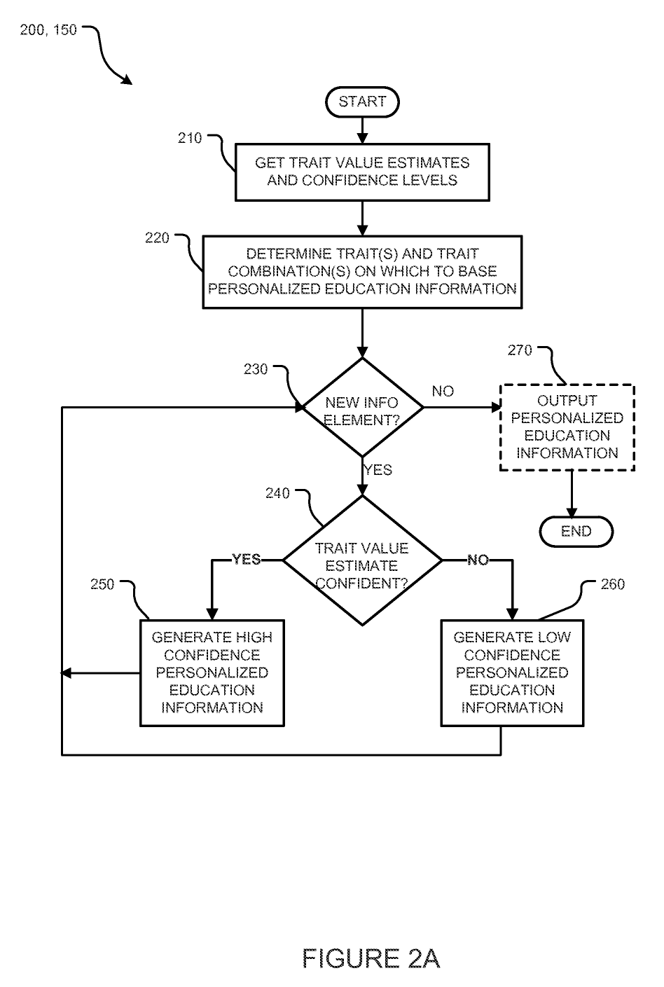

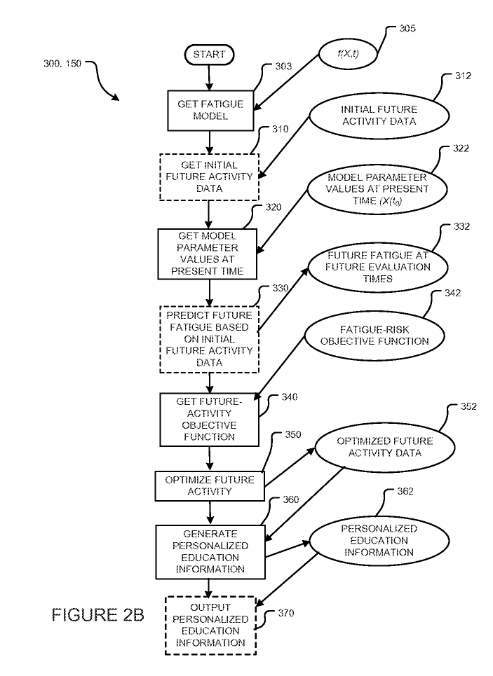

FIG. 2A is a schematic block diagram of a method 200 for using trait value estimates for fatigue-related individual traits of a subject (e.g. trait value estimates 142 generated in block 140 of method 100 (FIG. 1)) to determine personalized education information about the subject according to a particular embodiment. Method 200 provides one particular embodiment for implementing block 150 of method 100 (FIG. 1). In other embodiments, method 200 may be implemented independently of method 100 as described in more particular detail below.

Method 200 commences in block 210 which involves procuring trait value estimates for fatigue-related individual traits of a subject and corresponding confidence levels. In particular embodiments, the block 210 trait value estimates may comprise the trait value estimates 142 generated in block 140 of method 100, although this is not necessary. In other embodiments, the block 210 trait value estimates may be procured from one or more different sources, such as, by way of non-limiting example, some other trait-estimation technique which estimates fatigue-related traits of the subject, a model which provides trait estimates for fatigue-related traits of the subject, a trait measurement technique which attempts to measure the fatigue-related traits of the subject and/or the like.

Block 210 also involves procuring one or more confidence levels corresponding to each of the block 210 trait value estimates. In embodiments, where the trait value estimates are obtained from method 100, trait value estimates 142 generated in block 140 may comprise one or more statistical confidence metrics (e.g. variance, standard deviation or some other statistical confidence metric). Such confidence metrics may be used for the block 210 confidence levels. In other embodiments, the block 210 confidence level(s) for each corresponding trait may be obtained from one or more other sources which may include the same sources from which the trait value estimates are obtained of which may include one or more different sources.

In some embodiments, the block 210 trait value estimates may be generated based on information gathered from a representative population to which the subject may belong. For example, if the subject is a member of a group of night shift workers, trait values of the other night shift workers may be used as an estimate of the subject's trait values. In some cases, subject-specific trait value estimates obtained from the subject (e.g. via method 100) may supplement and/or replace trait value estimates obtained from populations. In some embodiments, the block 210 confidence levels may be estimated and assigned to particular trait value estimates. Such may be the case, for example, where the block 210 trait value estimates for a particular subject are based on trait values of a representative population.

Method 200 then proceeds to block 220 which involves determining which fatigue-related individual traits (or combinations of fatigue-related individual traits) will be used as the basis for ascertaining personalized educational information. The traits selected in block 220 comprise one or more of (or one or more combinations of) the traits for which trait value estimates were procured in block 210. In the simplest case, block 220 involves selection of a single fatigue-related individual trait for which a trait value estimate is available from block 210. In other cases, block 220 may involve selection of a plurality of fatigue-related individual traits for which trait value estimates are available from block 210. Block 220 may also involve selection of one or more combinations of fatigue-related individual traits for which trait value estimates are available from block 210. The block 220 selection may be user-configurable or may be a pre-configured characteristic of method 200.

Method 200 then proceeds to an inquiry in block 230 as to whether another element of personalized education information is desired. The block 230 inquiry provides the loop exit criteria for a method 200 loop that is performed once for each block 220 fatigue-related individual traits (or combination of fatigue-related individual traits). For brevity, the block 220 fatigue-related individual trait (or combination of fatigue-related individual traits) for a particular iteration of the method 200 loop may be referred to as the current trait and it will be understood that the current trait may actually include a combination of fatigue-related individual traits.

In the first iteration of method 200, the block 230 inquiry will be positive and method 200 will proceed to block 240. Block 240 involves an inquiry into the confidence level associated with the current trait. The confidence level associated with the current trait may come from the confidence levels procured in block 210. In cases where the current trait comprises a combination of fatigue-related individual traits, then a suitable function (e.g. an average, a sum, a peak-value function and/or the like) may be used to combine the block 210 confidence levels corresponding to the combination of fatigue-related individual traits. In particular embodiments, the block 240 inquiry comprises subjecting the confidence level for the current trait to a thresholding process. If the confidence level for the current trait is greater than the threshold, then the block 240 inquiry will be positive and method 200 will proceed to block 250. Conversely, if the confidence level for the current trait is less than the threshold, then the block 240 inquiry will be negative and method 200 will proceed to block 260.

In cases where the confidence level associated with the current trait is high, method 200 will end up in block 250. Block 250 may involve generating high-confidence personalized education information about the subject of method 200. Conversely, in cases where the confidence level associated with the current trait is low, method 200 will end up in block 260 which involves generating low-confidence personalized education information about the subject of method 200. In general, when comparing the block 250 high-confidence personalized education information and the block 260 low-confidence information, the block 250 high-confidence information may be relatively more specific to the subject and/or detailed and/or may involve educational information having relatively greater risk should it be relied on by a user or by the subject of method 200. Conversely, the block 260 low-confidence information may be relatively less specific to the subject and/or less detailed and/or may involve educational information having relatively less risk should it be relied on by a user or by the subject of method 200.

Generating high-confidence personalized education information in block 250 may comprise using a look up table indexed by the block 210 trait value estimate associated with the current trait for the current iteration of the method 200 loop. By way of non-limiting example, the block 210 trait value estimate associated with the current trait may fall within a range from 1-100 and the block 250 look up table may comprise ten entries, each entry comprising an element of personalized education information and each entry indexed by a range of trait values (e.g. 1-10, 11-20, 21-30 . . . 91-100). Generating high-confidence personalized education information in block 250 may then involve using the block 210 trait value estimate associated with the current trait of the method 200 loop to select a particular look up table entry and a corresponding element of personalized education information. In embodiments, where the current trait of the method 200 loop comprises a combination of fatigue-related individual traits, then the block 250 look up table may comprise a multi-dimensional look up table indexed by each of the fatigue-related individual traits or a single-dimensional look up table indexed by a suitable function of the fatigue-related individual traits.

Generating low-confidence personalized education information in block 260 may be similar to generating high-confidence personalized education information in block 250 except that the low-confidence personalized education information determined in block 260 uses a different look up table. Like block 250 discussed above, generating low-confidence personalized education information in block 260 may comprise using a look up table indexed by the block 210 trait value estimate associated with the current trait for the current iteration of the method 200 loop.

After generating high-confidence personalized education information in block 250 (or low-confidence information in block 260), method 200 loops back to block 230 to determine whether another element of personalized education information is desired. If another element of personalized education information is desired, then the block 230 inquiry is positive, the current trait is incremented to the next trait (or combination of traits) of interest and the method 200 loop is repeated for the new current trait. If the block 230 inquiry is negative, then method 240 proceeds to optional block 270 where the personalized education information is output (e.g. onto a computer display, into an electronic record, onto a print-out and/or the like).

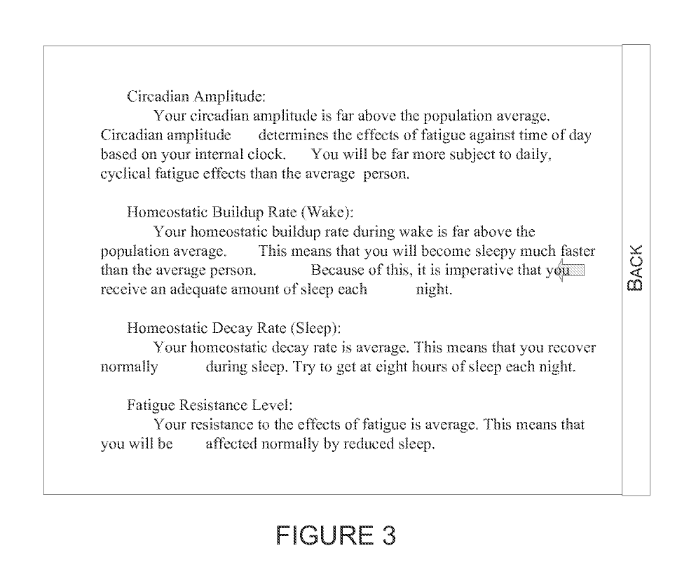

FIG. 3 schematically depicts block 270 output (e.g. a display screen) of a personalized education information summary according to an example embodiment. The personalized education information output in the FIG. 3 example includes subject-specific information based on four fatigue-related individual traits: circadian amplitude, homeostatic buildup rate while awake, homeostatic decay rate while asleep, and fatigue resistance. The personalized education information for each of these fatigue-related individual traits is clearly identified and, in the illustrated example, includes detailed information tailored to the subject of method 200 based on the trait value estimates for his/her fatigue-related individual traits. In the FIG. 3 example embodiment, the subject's trait value estimates are compared to, and/or categorized in relation to, a general or a specific population's average, and the relationship to that average (e.g., “average,” “above average,” “below average,” “far above average” etc.) forms part of the block 270 output. In other embodiments, such comparison information may comprise other forms of comparison, such as percentile ranking and/or the like.

Personalized education information determined in blocks 250 or 260 and optionally displayed in block 270 may contain general information about the meaning of fatigue-related individual traits and the corresponding trait value estimates for the subject. Where a subject's trait value estimates are (statistically) significantly different from a population norm, then personalized education information could be provided about whether the subject has a differential vulnerability or resistance to certain fatigue-related behaviors. This personalized education information may help a user (or subject) to better understand the subject's susceptibility to fatigue. Such personalized education information may be useful to provide some context for the material that had previously been known about a subject. Such personalized education information could allow a user or a subject to see how a subject's current schedule and sleep habits lead to potentially reduced levels of performance and may help create incentive to rigorously follow a fatigue education and management program. Such personalized education information may also allow a user or a subject to more accurately understand a subject's adequate amount of sleep, response to sleep restriction, response to circadian cycles, response to stimulants or other psychoactive substances, ability to adjust to different sleep and wake times, or other fatigue-related individual traits. Using such knowledge, a user or a subject will be more empowered to make informed decisions about activities that may have an effect on the subject's sleep pattern.

For each current trait, the FIG. 2A embodiment (method 200) involves the generation of either high confidence personalized education information (in block 250) or low confidence personalized education information (in block 260). In other embodiments, similar methods may be provided with more than two levels of confidence-based personalized education information. For example, the block 240 inquiry may be extended to conduct an inquiry into whether the level of confidence in the current trait falls into more than two confidence levels (e.g. low, medium or high medium confidence levels) and personalized education information may be generated for each such confidence level in accordance with techniques similar to those discussed above for block 250, 260.

FIG. 2B is a schematic block diagram of a method 300 for determining personalized education information for a subject according to another particular embodiment. Method 300 provides one particular embodiment for implementing block 150 of method 100 (FIG. 1). In other embodiments, method 300 may be implemented independently of method 100 as described in more particular detail below. Method 300 may involve an optimization process which uses an objective function (which may be referred to as a future-activity objective function without loss of generality) and which involves varying future activity data to obtain an acceptably minimized objective function output. The future-activity objective function may be based at least in part on a fatigue model ƒ(X,t) of the type described above.

Method 300 commences in block 303 which involves procuring a fatigue model 305. Fatigue model 305 may comprise a fatigue model ƒ(X,t) of the type described above. In some embodiments (e.g. where method 300 is used to implement block 150), the particular fatigue model 305 procured in block 303 may be the same as the fatigue model 105 procured in block 103 of method 100, although this is not necessary. In some embodiments, the particular fatigue model 305 procured in block 303 may be a user-configurable parameter. In other embodiments, the fatigue model 305 procured in block 303 may be a pre-configured characteristic of method 100.

Method 300 then proceeds to optional block 310 which involves procuring initial future activity data 312 for a subject. The block 310 initial future activity data 312 may involve projecting the likely activities of the subject into the future. Like activity history data 122 described above, the block 310 initial future activity data may comprise future sleep data (e.g. a projected future sleep/wake schedule and/or the like) and/or future wakeful activity data (e.g. a projected future schedule of work, travel plans, intake of caffeine (or other stimulants), light exposure and/or other wakeful activities). Future wakeful activity data may be procured from suitable scheduling data (e.g. an employer's scheduling system and/or the like). In some embodiments, future sleep activity may be estimated based on future wakeful activity data. For example, future sleep activity may be estimated by estimating that a subject will sleep during the largest unscheduled block of time during his day. An available future sleep time might be determined by excluding periods a set amount of time before and after scheduled future wakeful activity time to account for the time the subject spends doing things other than scheduled activities and sleeping. The amount of time that is excluded might be determined based on activity history data 122 (if available) by comparing historical times of sleep activity and wakeful activity. Also, the maximum sleep time might be set to an upper limit, such as eight hours. In some embodiments, subject-specific initial future activity data may not be available, in which case assumed future activity data may be provided based on an assumed sleep and/or wakeful activity schedule.

Method 300 then proceeds to block 320 which involves procuring model parameter values 322 for the block 303 fatigue model 305 at a present time t₀. In embodiments where the block 303 fatigue model 305 has the form ƒ(X,t), block 320 may involve procuring values 322 for the model parameters X at the present time t₀—i.e. X(t₀). In some embodiments (e.g. where method 300 is used to implement block 150), the block 320 model parameter values 322 may comprise the model parameter values X at the present time t₀ as may be determined in blocks 120 and/or 130 of method 100. In other embodiments (e.g. where method 300 is implemented independently of method 100), the block 320 model parameter values 322 may be procured in a manner similar to that described above for block 120 of method 100. More particularly, the block 320 model parameter values 322 may be based on activity history data, subject-specific model initialization data and/or other model initialization data (see the above description of block 120 and activity history data 122, subject-specific model initialization data 124 and other model initialization data 126). As discussed above, the specific manner in which activity history data, subject-specific model initialization data and/or other model initialization data are incorporated into model parameters X depends on the characteristics of the particular fatigue model ƒ(X,t) and the nature of the activity history data, the subject-specific model initialization data and/or the other model initialization data.

Method 300 then proceeds to optional block 330 which involves predicting future fatigue levels 332 using the block 303 fatigue model 305, the block 320 model parameters 322 at the present time t₀ and the block 310 initial future activity data 312. The block 330 future fatigue levels 332 may be predicted at one or more future evaluation times t=T₁, T₂, . . . Tₖ. For each future evaluation time t=T₁, T₂, . . . Tₖ, the model parameters X of the fatigue model ƒ(X,t) may be updated from their values at the present time t₀—i.e. to reflect their time dependence on time up to and including the future evaluation time and their dependence on initial future activity data 312 up to and including the future evaluation time. As will be understood by those skilled in the art and familiar with fatigue models, the specific manner in which initial future activity data 312 is incorporated into model parameters X depends on the characteristics of the particular fatigue model ƒ(X,t) and the specific characteristics of initial future activity data 312. In some embodiments, personalized education information 362 can be generated directly from the block 330 future fatigue levels 332.

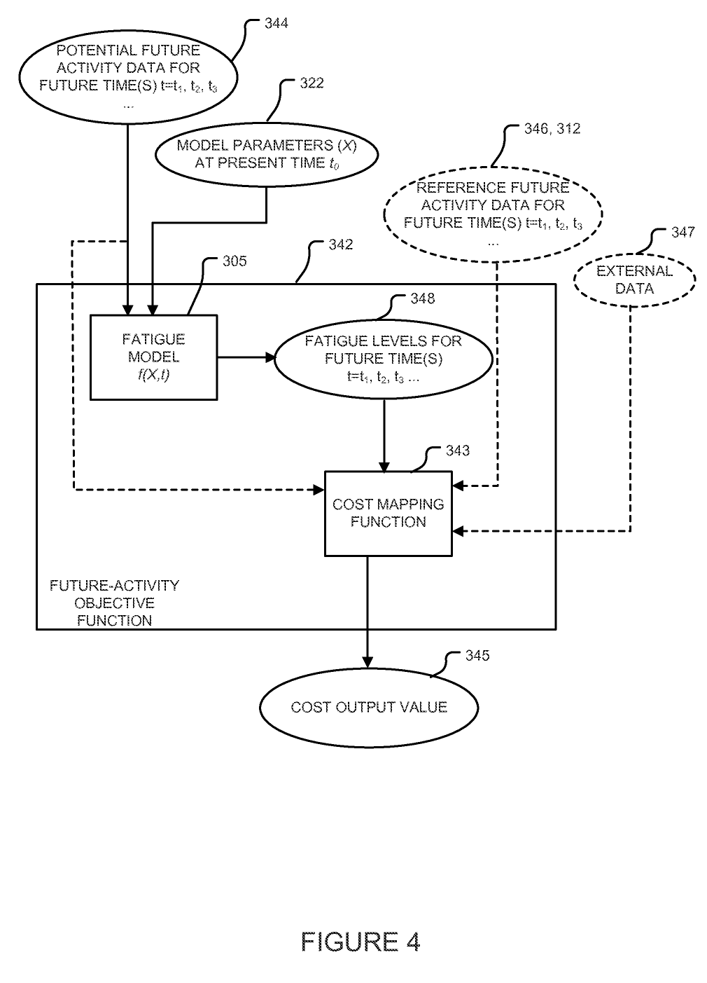

Method 300 then proceeds to block 340 which involves procuring or otherwise determining a future-activity objective function 342. The block 330 future-activity objective function 342 may itself be a function of the block 303 fatigue model 305 evaluated at one or more future evaluation times t=T₁, T₂, . . . Tₖ. FIG. 4 schematically depicts a future-activity objective function 342 according to a particular embodiment. As can be seen from FIG. 4, future-activity objective function 342 receives (as inputs) values 322 for a set of model parameters X at the present time t₀ and potential future activity data 344 for the subject at one or more future evaluation times t=T₁, T₂, . . . Tₖ and outputs a future cost value 345 (also referred to as future cost 345), which may be single-valued. In some embodiments, future cost 345 may be considered to be the fatigue-risk cost associated with potential future activity data 344. Potential future activity data 344 may be considered to be relatively more desirable (or relatively less risky) when future cost 345 is relatively low. In other embodiments, future cost 345 may be indicative of some other fatigue-related cost associated with potential future activity data 344. Potential future activity data 344 may be considered to be relatively more desirable when future cost 345 is relatively low.

In the illustrated embodiment of FIG. 4, objective function 342 incorporates the block 303 fatigue model 305. Fatigue model 305 may receive (as inputs) values 322 for a set of model parameters X at the present time t₀ and potential future activity data 344 for the subject at one or more future evaluation times t=T₁, T₂, . . . Tₖ and outputs fatigue levels 348 for the future evaluation times t=T₁, T₂, . . . Tₖ.

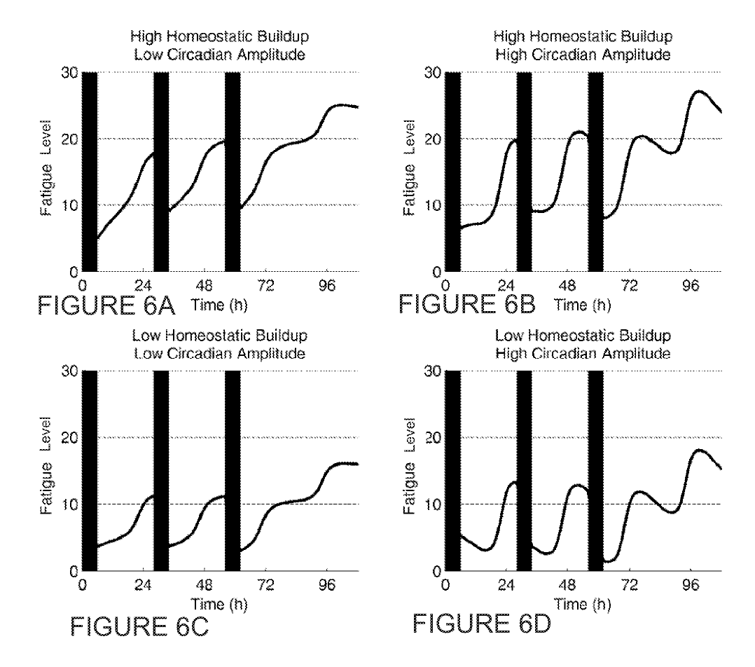

FIGS. 6A-6D show representative plots of fatigue levels 348 output by fatigue model 305 for four representative subjects having different fatigue-related individual traits. For illustrative purposes, FIGS. 6A-6D are based on the assumption that potential future activity data is the same for each of the individuals and that each individual starts at time (6 hours) with the same level of fatigue. The subjects of FIGS. 6A-6D have different fatigue-related individual traits—more particularly, the subject of FIG. 6A has a relatively high trait value for the homeostatic build-up parameter (see discussion above of homeostatic build-up parameter ( [symbol] _{w})) and a relatively low trait value for the circadian amplitude (see discussion above of circadian amplitude (γ)); the subject of FIG. 6B has relatively high trait values of both homeostatic build-up and circadian amplitude; the subject of FIG. 6C has relatively low trait values of both homeostatic build-up and circadian amplitude; and the subject of FIG. 6D has relatively low trait values for homeostatic build-up and a relatively high trait value for circadian amplitude.

Comparing FIGS. 6A-6D, it can be seen that individuals with relatively high trait values for homeostatic build-up tend to get fatigued relatively more quickly than individuals with relatively low trait values for homeostatic build-up. It can also be seen from FIGS. 6A-6D that individuals with relatively high trait values for circadian amplitude have greater fatigue swings at various times during the day. Assuming, for the purposes of description, that fatigue levels below 10 represent low-risk levels (e.g. where it might be desirable to perform work activity), fatigue levels between 10-20 represent moderate-risk levels (e.g. where it might be desirable to use extreme caution when performing work activity) and fatigue levels over 20 represent high-risk levels (e.g. where it might not be desirable to perform work activity). FIGS. 6A-6D show how personalized education information 362 (see discussion of blocks 360 and 370 below) for each subject will be related to the subject's fatigue-related individual traits. For example, each subject in FIGS. 6A-6D may be recommended to work at different times, to use caution when working at different times; and to avoid working at different times. Each subject may be recommended to change their future activity data (e.g. their sleep times or their stimulant intake) if their working times are not flexible.

It will be appreciated that the fatigue levels 348 shown in FIGS. 6A-6D could represent the block 330 future fatigue levels 332—i.e. in circumstances where initial future activity data 312 is the potential future activity data 344. It will be appreciated from FIGS. 6A-6D and the discussion above how future fatigue levels 332 could be used directly to generated personalized education information 362 (see further discussion of personalized fatigue education below).

Referring back to FIG. 4, objective function 342 may also incorporate a cost-mapping function 343 which receives (as inputs) future fatigue levels 348 at future evaluation times t=T₁, T₂, . . . Tₖ and which outputs future cost 345. By way of non-limiting example, cost-mapping function 343 may be based on: a sum (or integral) of future fatigue levels 348, an average of future fatigue levels 348, a maximum of future fatigue levels 348, a period of time that that future fatigue levels 348 are above a threshold, a weighted sum of future fatigue levels 348 where the future fatigue level at each future evaluation time t=T₁, T₂, . . . Tₖ is assigned a weight (e.g. where the weight attributed to each future fatigue-level prediction may depend on one or more of: the fatigue level of the prediction itself; the evaluation time of the fatigue-level prediction; a confidence level associated with the fatigue-level prediction; and/or the like); and/or the like. Cost-mapping function 343 may be based on an assessment of fatigue-risk associated with future fatigue levels 348 at future evaluation times t=T₁, T₂, . . . Tₖ. For example, cost-mapping function 343 may attribute relatively more cost or weight to future fatigue levels 348 that are above one or more future fatigue level thresholds.

In some embodiments, cost-mapping function 343 may optionally be based on information supplemental to future fatigue levels 348. In particular embodiments, cost-mapping function 343 may also depend on potential future activity data 344. By way of non-limiting example, it may be desirable that cost-mapping function 343 reflect the desirability of (e.g. attribute value to, or reduce cost for) some types of productive future activity (e.g. future work activity and/or the like).

In particular embodiments, cost-mapping function 343 may also depend on a reference set of future activity data 346 for the subject at future evaluation times t=T₁, T₂, . . . Tₖ. For example, in some embodiments, reference future activity data 346 may comprise the block 310 initial future activity data 312 and cost-mapping function 343 may be based, in part, on a magnitude of differences between initial future activity data 312, 346 and potential future activity data 344 at future evaluation times t=T₁, T₂, . . . Tₖ. A cost-mapping function 343 in accordance with such an example embodiment may be designed to penalize (or attribute cost to) changes from initial future activity data 312.

In particular embodiments, cost mapping function 343 may also depend on external data 347. By way of non-limiting example, such external data may comprise work-force production data which cost-mapping function 343 may combine with the duration and/or type of potential future activity data 344 to incorporate a cost representative of economic cost or may combined with future fatigue levels 348 to incorporate a cost representative of accident (or other fatigue-related) risk. Non-limiting example of work-force production data include: time periods in which machinery in a factory is available for use, availability of trucks for use by drivers, a desired production output target (e.g. number of miles driven, quantity of units produced, production line error rate limits, and/or the like), and/or the like.

The block 340 objective function 342 (or portions thereof) may comprise user-configurable aspects of method 300 or may comprise pre-configured aspects of method 300. In particular embodiments, a user may specify criteria to which cost should be attributed and/or weights for such criteria and such user specifications may be incorporated into objective function 342 (as parameters of cost-mapping function 343, for example).

Method 300 then proceeds to block 350 which involves performing an optimization procedure wherein potential future activities (i.e. potential future activity data 344 (FIG. 4)) are permitted to vary to minimize the future cost 345 associated with objective function 342 (or at least to reduce the future cost 345 associated with objective function 342 to an acceptably low level). The output of block 350 is a set of optimized future activity data 352. The block 350 optimization may be performed over a set of future evaluation times t=T₁, T₂, . . . Tₖ. While optimized future activity data 352 output from block 350 may also be specified for the set of future evaluation times t=T₁, T₂, . . . Tₖ, this is not necessary. In some embodiments, the block 350 optimization process may also output the future cost 345 (FIG. 4) associated with optimized future activity data 352, although this is not necessary.

In general, the block 350 optimization operation may comprise any suitable optimization technique. Non-limiting examples of suitable optimization techniques include: least squares fitting, Newton's method, the simplex method, quasi-Newton methods, simulated annealing, genetic search algorithms and/or the like. In some embodiments, the block 350 optimization operation may involve minimizing future cost 345 associated with objective function 342. This is not necessary, however; in some embodiments, the block 350 optimization process may involve minimizing future cost 345 associated with objective function 342 to an acceptably low level (e.g. below a threshold which may be user-configurable or pre-configured).

While not expressly shown in FIG. 2B, method 300 may involve ascertaining some calibration (e.g. constraint) information relating to the block 350 optimization process. Such constraints may limit the ability of potential future activity data 344 to vary. By way of non-limiting example, such constraints may require: a minimum daily amount of sleep time for the subject; a non-variable working schedule for the subject; a minimum daily amount of work for the subject; a maximum rate of stimulant intake for the subject; the subject to comply with applicable work-related regulations (e.g. for pilots, truck drivers and/or the like), and/or the like. As another example, such calibration information may include suitable optimization termination conditions—i.e. conditions that dictate when the future cost 345 associated with objective function 342 is reduced to an acceptably low level.

In particular embodiments, the block 350 optimization may involve using statistical modeling techniques, such as Bayesian forecasting by way of non-limiting example, to determine statistically optimized future activities 352 which minimize objective function 342 or otherwise reduce objective function to an acceptably low level. When using a statistical method, such as Bayesian forecasting for example, to determine optimized future activity data 352 in block 350, it may be beneficial to iterate through the forecasting method at successive future evaluation times t=T₁, T₂, . . . Tₖ. Usually, when more statistical modeling iterations occur, the resultant estimates of the optimum future activity data will be relatively more accurate. In particular embodiments, a statistical measure of confidence in optimized future activity data 352 may be determined as a part of block 350. In some embodiments, if such a statistical measure of confidence in optimized future activity data 352 is below a threshold, optimized future activity data 352 may not be output or otherwise provided to a user.

Method 300 then proceeds to block 360 which generates personalized education information 362 based on the block 350 optimized future activity data 352. In the illustrated embodiment, personalized education information 362 is based on the block 350 optimized future activity data 352. However, personalized education information 362 may additionally or alternatively be based on any information available to method 300. Non-limiting examples of personalized education information 362 based on the block 350 optimized future activity data 352 include: recommended future activity schedules (which may include future sleep schedules and/or future wakeful activity schedules) based on optimized future activity data 352 for reducing fatigue risk or for achieving some other fatigue-related objective (which objective may be reflected in cost function 342); information which compares fatigue risk or some other fatigue-related objective (which objective may be reflected in cost function 342) between the optimized future activity data 352 and initial future activity data 312; recommended changes to initial future activity data 312 based on optimized future activity data 352; other prescriptive countermeasures (e.g. an optimized time to commence a next sleep period, an optimized time for stimulant intake and an optimized stimulant amount and/or the like); and/or the like.

In some embodiments directed toward the management of a work force or military unit, personalized education information 362 may comprise additional employment or deployment instructions. For such embodiments, additional instructions may include, by way of non-limiting example: instructions for the subject to dismiss himself or herself from work or active duty; the filling out of specific employer-provided paperwork; an update status on the subject's recent fatigue-related employment activity (e.g., how many times in the past week, month, quarter or year the subject has had to dismiss himself or herself from active work or military duty, etc.).

Method 300 may proceed to block 370 which optionally outputs personalized education information 362 (e.g. onto a computer display, into an electronic record, onto a print-out and/or the like). In some embodiments, personalized education information may be output to the subject, but in other embodiments, personalized education information is output only to the user (and not the subject), such as may be the case when sensitive employment decisions must be made (e.g., termination, dismissal etc.).

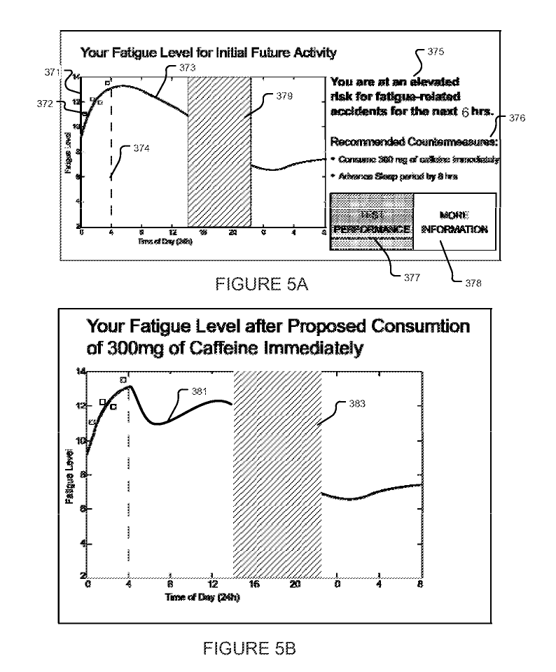

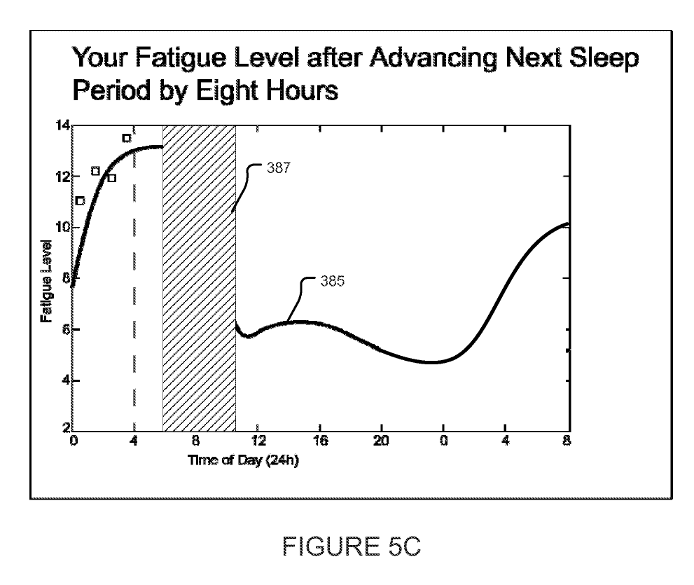

FIGS. 5A-5C schematically depict some potential block 370 output (e.g. a display screen) of personalized education information 362 according to an example embodiment. In the illustrated embodiment of FIG. 5A outputs, among other things, a graph 371 of fatigue level versus time for the initial future activity data 312 of a subject. In the illustrated embodiment of FIG. 5A, small squares 372 represent the block 110 first input data (e.g. fatigue measurements from previously taken fatigue tests and/or the like). In the illustrated embodiment of FIG. 5A, future fatigue levels 332 predicted by the fatigue model 305 for the initial future activity data 312 of the subject are the represented by the curve 373 with the dashed line 374 representing the present time and hatched region 379 representing a future sleep period. The FIG. 5A exemplary display also includes textual personalized education information 375. In the illustrated embodiment, it is assumed for the sake of description that fatigue levels over 12 represent elevated fatigue risk. Accordingly, textual personalized education information 375 indicates that the subject is at an elevated level of fatigue risk for the next 6 hours. The FIG. 5A exemplary personalized education information also displays a number of countermeasures 376 which may be based on optimized future activity data 352 (see FIG. 2A). In the example, countermeasures 376 include immediately consuming caffeine and advancing the initial future sleep period by 8 hours. Countermeasures 376 may not have recommended immediate sleep because of some constraint imposed during the block 350 optimization. The exemplary FIG. 5A output screen also includes an option 378 for providing more detailed information or for accessing general or specific education information.

FIG. 5B shows other potential block 370 output of personalized education information 362 according to an example embodiment. In the illustrated embodiment, FIG. 5B may represent a display screen that comes up when a user exercises the option 378 (FIG. 5A) for more information. FIG. 5B shows a plot 381 depicting the predicted future fatigue levels for the subject assuming that the subject's future activity data is modified by immediate consumption of 300 mg of caffeine. The recommendation to consume 300 mg of caffeine may be based on optimized future activity data. It can be seen from plot 381 of FIG. 5B, that the period of time when the subject's future fatigue level is greater than 12 is reduced by the proposed countermeasure. Plot 381 also shows that the subject's fatigue rises above the level 12 at approximately 13 hours. While further caffeine intake may remedy this high fatigue level, the recommendation of further caffeine intake at that time may have been prevented by a constraint imposed during the block 350 optimization that limits stimulant intake in a period preceding proposed future sleep period 383.

FIG. 5C shows other potential block 370 output of personalized education information 362 according to an example embodiment. In the illustrated embodiment, FIG. 5C may represent a display screen that comes up when a user exercises the option 378 (FIG. 5A) for more information. FIG. 5C shows a plot 385 depicting the predicted future fatigue levels for the subject assuming that the subject's future activity data is modified by advancing the proposed sleep period 379 (FIG. 5A) by eight hours as shown in sleep period 387 (FIG. 5C).

Returning to FIG. 5A, the illustrated screen provides an input option 377 to initiate a performance test which may generate another sample of the block 110 first input data (FIG. 2A). At certain times, it may be desirable to have option 377 to initiate a performance test disabled. For instance, too little time may have elapsed since the last performance test was taken, or option 377 may be disabled for safety purposes.

While not shown in the particular examples of FIGS. 5A-5C, the block 370 output may comprise plots of other related variables, such as performance, alertness, or any other desired variable. In some implementations, it may be desirable to show more than one plot or to have an option to cycle between several plots.

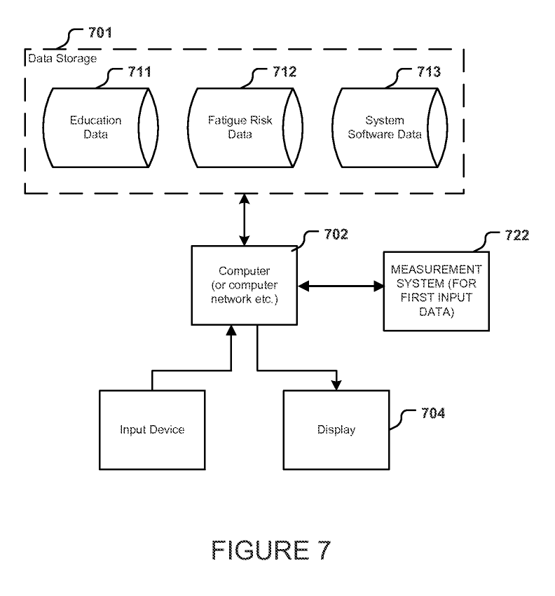

Particular embodiments of the invention may be implemented using suitably configured computer systems. FIG. 7 shows a schematic illustration of a system 700 for providing personalized education information according to a particular, non-limiting, embodiment. The illustrated system 700 comprises: data storage 701, a computer or computer network 702 (e.g. any device with suitable processing capacity and I/O capabilities, including networked computers, intranets, the Internet, mobile computing platforms, embedded devices, etc.), input device 703, and a display 704. In some implementations, some of these components may be the components that make up a personal computer, a mobile phone, personal media player, or any other device that contains the four aforementioned basic components. Data storage 701 may optionally contain education information data 711, fatigue-risk data 712, and system software data 713. System software 713, when executed by computer 702, can cause computer 702 to perform the methods described herein. Education information data 711 and/or fatigue-risk data 712 can be used by computer 702 when performing such methods. Fatigue risk data 712 may optionally comprise fatigue models and/or objective functions (as described herein). Fatigue-risk data 712 may comprise subject specific information and population based information. FIG. 7 may optionally comprise a measurement system 722 for measuring or otherwise observing first input data (see block 110 of method 100 (FIG. 1)).

Certain implementations of the invention comprise computer processors which execute software instructions which cause the processors to perform a method of the invention. For example, one or more processors may implement data processing steps in the methods described herein by executing software instructions retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

As will be apparent to those skilled in the art in light of the foregoing disclosure, many alterations and modifications are possible in the practice of this invention without departing from the spirit or scope thereof. For example:
Portions of the description referred to above may refer to optimization processes which involve minimizing objective (cost) functions or otherwise reducing objective (cost) functions. As is known to those skilled in the art of mathematical optimization, optimization processes can be designed to maximize (or increase) objective (cost) functions. Optimization processes as used herein should be considered to incorporate minimizing (or reducing) and/or maximizing (increasing) objective (cost) functions.
In some embodiments, block 150 of method 100 (FIG. 1) may comprise implementing both method 200 (FIG. 2A) and method 300 (FIG. 2B) to obtain a variety of personalized education information.
In some embodiments, method 200 (FIG. 2A) may be modified to be independent of confidence level of the current trait. In such embodiments, personalized education information may be obtained from a single look up table indexed by the estimated trait value of the current trait. Effectively, such an embodiment would involve removing block 240 and collapsing blocks 250 and 260 into a single procedure with a single corresponding look up table.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for ascertaining personalized education information related to one or more fatigue-related individual traits of a subject, the method comprising:
receiving first input data indicative of an expression of one or more fatigue-related individual traits of the subject;
estimating trait values for the one or more fatigue-related individual traits, wherein estimating the trait values comprises: using the first input data and a fatigue model, which relates a fatigue level of the subject to a set of model parameters, to estimate values for the set of model parameters; and evaluating one or more trait-estimation functions using the estimated values for the set of model parameters; and
determining personalized education information about the one or more fatigue-related individual traits of the subject based on the estimated trait values.

2. A method according to claim 1 wherein using the first input data and the fatigue model to estimate values for the set of model parameters comprises: performing an optimization process, the optimization process involving varying a subset of the model parameters to determine one or more corresponding optimized model parameter values where the fatigue model evaluated using the one or more optimized model parameter values predicts the first input data to an acceptably accurate level; and using the one or more optimized model parameter values as estimated values for the subset of model parameters.

3. A method according to claim 2 wherein performing the optimization process involves minimizing an objective function to an acceptably low level, the objective function representative of a difference metric between the first input data and one or more fatigue levels predicted by the fatigue model at one or more corresponding evaluation times.

4. A method according to claim 3 wherein performing the optimization process comprises maintaining a second subset of the model parameters constant at each of the one or more evaluation times, the second subset of the model parameters based at least in part on activity history data of the subject.

5. A method according to claim 2 wherein performing the optimization process comprises performing an iterative Bayesian forecasting process over one or more evaluation times to determine the one or more optimized model parameter values.

6. A method according to claim 5 wherein performing the optimization process comprises maintaining a second subset of the model parameters constant at each of the one or more evaluation times, the second subset of the model parameters based at least in part on activity history data of the subject.

7. A method according to claim 2 wherein the subset of model parameters comprises at least one statistical model parameter representative of a probability distribution and wherein the corresponding optimized model parameter values for the at least one statistical model parameter comprise an expected value of the probability distribution and an indication of confidence in the expected value.

8. A method according to claim 7 wherein evaluating one or more trait-estimation functions using the estimated values for the set of model parameters comprises evaluating at least one trait-estimation function using the optimized model parameter values for the at least one statistical model parameter to determine an expected value of a probability distribution the estimated trait value and an indication of confidence in the expected value for the estimated trait value.

9. A method according to claim 8 wherein determining personalized education information comprises:
comparing the indication of confidence in the expected value for the estimated trait value to a confidence threshold; and
if the indication of confidence in the expected value for the estimated trait value is greater than the confidence threshold, then selecting the personalized education information from a first set personalized education information; and
if the indication of confidence in the expected value for the estimated trait value is less than the confidence threshold, then selecting the personalized education information from a second set of personalized education information.

10. A method according to claim 9 wherein the first set of personalized information comprises a first plurality of elements of personalized education information organized into a first indexed table and wherein selecting the personalized education information from the first set of personalized education information comprises using the expected value for the estimated trait value as an index to select a particular element of personalized education information from the first indexed table.

11. A method according to claim 10 wherein the second set of personalized information comprises a second plurality of elements of personalized education information organized into a second indexed table and wherein selecting the personalized education information from the second set of personalized education information comprises using the expected value for the estimated trait value as an index to select a particular element of personalized education information from the second indexed table.

12. A method according to claim 2 wherein estimating trait values for the one or more fatigue-related individual traits comprises, for at least one estimated trait value, determining an expected value of a probability distribution for the at least one estimated trait value and an indication of confidence in the expected value for the at least one estimated trait value.

13. A method according to claim 12 wherein determining personalized education information comprises:
comparing the indication of confidence in the expected value for the at least one estimated trait value to a confidence threshold; and
if the indication of confidence in the expected value for the at least one estimated trait value is greater than the confidence threshold, then selecting the personalized education information from a first set personalized education information; and
if the indication of confidence in the expected value for the at least one estimated trait value is less than the confidence threshold, then selecting the personalized education information from a second set of personalized education information.

14. A method according to claim 13 wherein the first set of personalized information comprises a first plurality of elements of personalized education information organized into a first indexed table and wherein selecting the personalized education information from the first set of personalized education information comprises using the expected value for the at least one estimated trait value as an index to select a particular element of personalized education information from the first indexed table.

15. A method according to claim 14 wherein the second set of personalized information comprises a second plurality of elements of personalized education information organized into a second indexed table and wherein selecting the personalized education information from the second set of personalized education information comprises using the expected value for the at least one estimated trait value as an index to select a particular element of personalized education information from the second indexed table.

16. A method according to claim 1 wherein determining personalized education information comprises:
considering the estimated values for the set of model parameters to be a set of present model parameters for a present time;
providing a set of potential future activity data for the subject at one or more future evaluation times;
providing a future-activity objective function which receives, as inputs, the present model parameters and the set of potential future activity data and which outputs a future cost value;
performing a future-activity optimization process based on the future-activity objective function to obtain optimized future activity data at the one or more future evaluation times, wherein performing the future-activity optimization process comprises permitting the set of potential future activity data to vary until the future cost value output from the future-activity objective function is acceptably low;
determining the personalized educational information based at least in part on the optimized future activity data.

17. A method according to claim 16 wherein the future-activity objective function comprises: the fatigue model which uses the present model parameters and the set of potential future activity data to generate future fatigue level predictions at the one or more future evaluation times; and a cost-mapping function which determines the future cost value based at least in part on the future fatigue level predictions at the one or more future evaluation times.

18. A method according to claim 17 wherein cost-mapping function is based at least in part on a sum of the future fatigue level predictions at the one or more future evaluation times.

19. A method according to claim 17 wherein the cost-mapping function is based at least in part on a weighted sum of the future fatigue-level predictions at the one or more future times and wherein the weights attributed to each future fatigue-level prediction depend on one or more of: the fatigue level of the prediction; the evaluation time of the fatigue-level prediction; and a confidence level associated with the fatigue-level prediction.

20. A method according to claim 17 wherein the cost-mapping function is based at least in part on one or more of: a maximum one of the future fatigue level predictions; an average o the future fatigue level predictions; and a number of the future fatigue level predictions where the future fatigue level is greater than a threshold.

21. A method according to claim 17 wherein the dependence of the cost-mapping function on the future fatigue level predictions at the one or more future evaluation times attributes cost based on fatigue-related risk wherein future fatigue level predictions above one or more threshold are attributed relatively greater cost.

22. A method according to claim 17 wherein the cost mapping function determines the future cost value based at least in part on the set of potential future activity data.

23. A method according to claim 22 wherein the dependence of the cost-mapping function on the set of potential future activity data attributes value to productive wakeful future activity data.

24. A method according to claim 17 wherein the cost mapping function determines the future cost value based at least in part on a reference set of future activity data for the one or more future evaluation times.

25. A method according to claim 24 wherein the cost-mapping function is based at least in part on differences between the set of potential future activity data and the reference set of future activity data over the one or more future evaluation times.

26. A method according to claim 16 wherein the personalized education information comprises one or more recommended future activities for the subject based on the optimized future activity data.

27. A method according to claim 26 wherein the one or more recommended future activities comprise a recommendation for the subject to sleep during one or more particular time periods.

28. A method according to claim 26 wherein the one or more recommended future activities comprise a recommendation for the subject to receive a dose of stimulant at one or more particular times.

29. A method according to claim 26 wherein the one or more recommended future activities comprises a recommendation to avoid high-risk activities at one or more particular times.

30. A method according to claim 16 wherein performing the future-activity optimization process is subject to one or more constraints relating to permitted variations to the set of potential future activity data.

31. A method according to claim 30 wherein the one or more constraints comprise at least one of: a minimum daily amount of sleep time for the subject; a non-variable working schedule for the subject; a minimum daily amount of work for the subject; and maximum rate of stimulant intake for the subject.

32. A method according to claim 30 wherein the one or more constraints are based on regulations governing working activity of the subject.

33. A method according to claim 13 wherein determining personalized education information comprises:
considering the estimated values for the set of model parameters to be a set of present model parameters for a present time;
providing a set of potential future activity data for the subject at one or more future evaluation times;
providing a future-activity objective function which receives, as inputs, the present model parameters and the set of potential future activity data and which outputs a future cost value;
performing a future-activity optimization process based on the future-activity objective function to obtain optimized future activity data at the one or more future evaluation times, wherein performing the future-activity optimization process comprises permitting the set of potential future activity data to vary until the future cost value output from the future-activity objective function is acceptably low;
determining the personalized educational information based at least in part on the optimized future activity data.

34. A method for ascertaining personalized education information related to one or more fatigue-related individual traits of a subject, the method comprising:
providing a set of present model parameters for a present time, the set of present model parameters comprising a subset of model parameters based on one or more trait value estimates for one or more corresponding fatigue-related individual traits of the subject;
providing a set of potential future activity data for the subject at one or more future evaluation times;
providing a future-activity objective function which receives, as inputs, the present model parameters and the set of potential future activity data and which outputs a future cost value;
performing a future-activity optimization process based on the future-activity objective function to obtain optimized future activity data at the one or more future evaluation times, wherein performing the future-activity optimization process comprises permitting the set of potential future activity data to vary until the future cost value output from the future-activity objective function is acceptably low;
determining personalized educational information based at least in part on the optimized future activity data.

35. A method according to claim 34 comprising providing a fatigue model which relates a fatigue level of the subject to a set of model parameters and wherein the future-activity objective function comprises: the fatigue model which uses the present model parameters and the set of potential future activity data to generate future fatigue level predictions at the one or more future evaluation times; and a cost-mapping function which determines the future cost value based at least in part on the future fatigue level predictions at the one or more future evaluation times.

36. A computer program product provided in a form of a non-transitory medium comprising software instructions which, when executed by a suitably configured processor, cause the processor to perform the method of claim 1.

37. A computer program product provided in the form of a non-transitory medium comprising software instructions which, when executed by a suitably configured processor, cause the processor to perform the method of claim 34.
